(19) United States
(12) Patent Application Publication
(10) Pub. No.: US 2008/0042803 A1
(43) Pub. Date: Feb. 21, 2008

(54) ADJUSTING SIGNAL STRENGTH USED TO DETECT TAGS

(76) Inventor: Joshua Posamentier, Oakland, CA (US)

Correspondence Address: KONRAD RAYNES & VICTOR, LLP.;ATTN: INT77, 315 SOUTH BEVERLY DRIVE, SUITE 210, BEVERLY HILLS, CA, 90212, US

(21) Appl. No.: 11/460,594

(22) Filed: Jul. 27, 2006

(51) Int. Cl. H04Q 5/22

(52) U.S. Cl. 340/10.1; 340/572.1; 340/10.34

(57) ABSTRACT

Provided are a method, system, and article of manufacture for adjusting signal strength used to detect tags. A signal is emitted at an initial power to activate electronically responsive tags. A response is received from one of the tags to the emitted signal. A determination is made of an indicator of a signal strength received at the responding tag. A power of the emitted signal is adjusted downward based on the determined indicator of the signal strength.

### BACKGROUND

Radio Frequency Identification (RFID) technology is used to identify and remotely access information from RFID tag or transponders. An RFID tag is a small object that can be attached to or incorporated into a product, animal, or person. RFID tags contain silicon chips and antennas to enable them to receive and respond to radio-frequency queries from an RFID interrogator, which acquires information from the RFID tags to manage the elements to which the tags are attached. Passive tags require no internal power source, whereas active tags require a power source.

Certain RFID interrogators employ a listen before talk (LBT) algorithm where the interrogator emits a signal to query for RFID tags only when it does not detect signals of a certain minimum strength for a certain period of time. The European Telecommunications Standards Institute (ETSI) currently requires that RFID interrogation devices in Europe employ such LBT technology to avoid transmitting if radio frequency signals of a certain strength are detected. One impact of these regulations is to limit the usability of multiple RFID interrogators that attempt to interrogate within each others' electromagnetic zones.

### BRIEF DESCRIPTION OF THE DRAWINGS

FIG. 1 illustrates an embodiment of a device communication system.

FIGS. 2, 3, and 4 illustrate embodiments of operations to detect tags.

### DETAILED DESCRIPTION

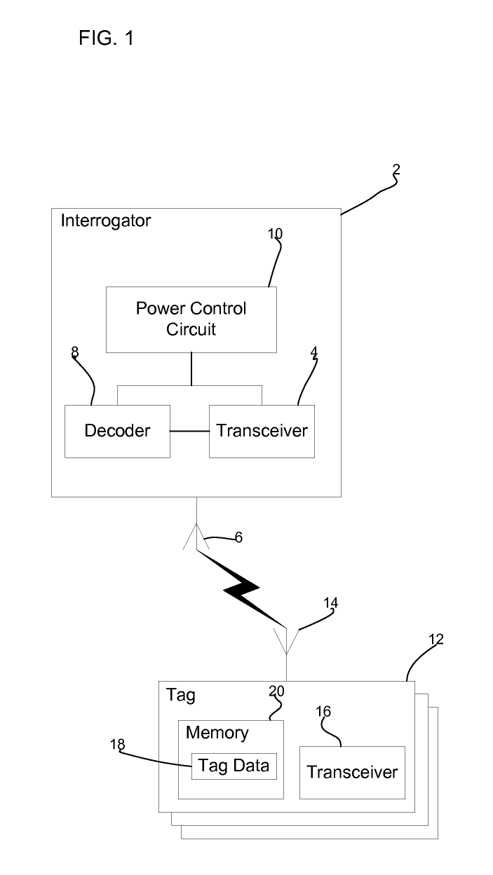

FIG. 1 illustrates a device communication environment in which described embodiments are implemented. An interrogator 2, such as an RFID reader or interrogator, includes a transceiver 4 to transmit and receive signals through an antenna 6 and a decoder 8 to decode information from signals received at the transceiver 4. A power control circuit 10 controls the strength or amplitude of signals the transceiver 4 transmits through the antenna 6. One or more electronically responsive tags 12, also referred to as “tags”, each has an antenna 14 to receive signals transmitted by the interrogator 2. The tags 12 comprise a signal processing device that emits an electronic response to a received signal, such as passive RFID tags. The electrical current induced in the antenna 14 by the incoming radio frequency signal from the interrogator 2 provides sufficient power to power-up the tag 12 and allow the tag 12 transceiver 16 to receive and process the signal from the interrogator 2 and transmit a response. In certain embodiments, the tag 12 may backscatter the carrier signal from the reader to transmit a response signal to the interrogator 2. The tag 12 may further encode a response signal with tag data 18 in a memory 20 of the tag 12, such as a globally unique identifier (GUID) and other tag information, such as information on the element to which the tag is attached. The memory 20 may comprise a non-volatile memory device, such as an electronically erasable programmable read only memory (EEPROM), flash memory, etc.

In one embodiment, the interrogator 2 implements “listen before talk” (LBT) mode in which the interrogator 2 listens for a signal of a minimum strength (i.e., amplitude) from an external interrogator and only transmits the signal to activate tags if the interrogator 2 does not detect a signal of at least the minimum amplitude for a predetermined wait time from an external interrogator. In alternative embodiments, the interrogator 2 may not implement LBT technology.

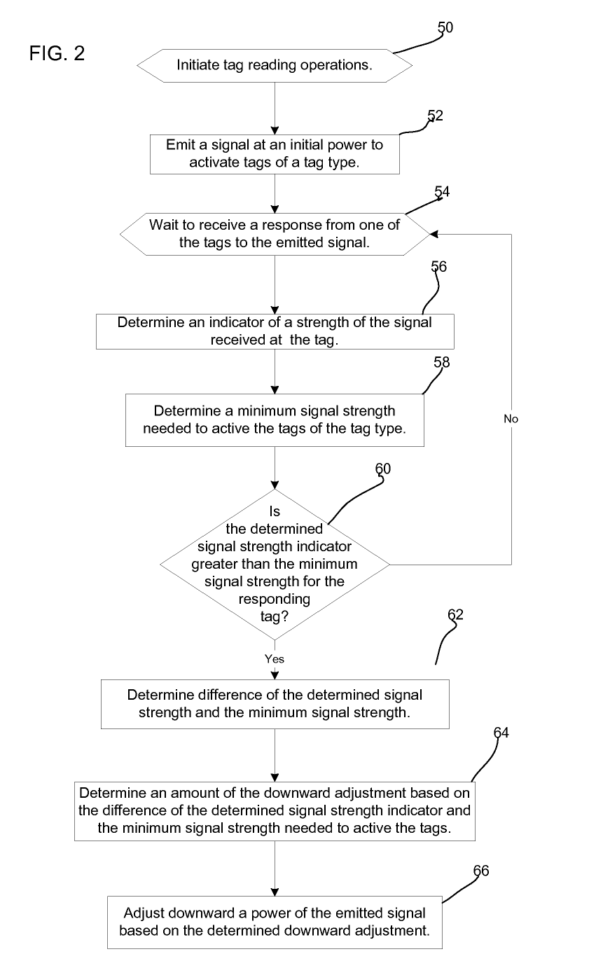

FIG. 2 illustrates an embodiment of operations performed by the interrogator 2 components, such as the power control circuit 10, transceiver 4, decoder 8, and antenna 6 to control the transmission of a signal for a particular class of tags. Upon initiating tag reading operations (at block 50) to detect tags of a particular class, the power control circuit 10 may cause (at block 52) the transceiver 4 to emit a signal at an initial power to activate tags of a tag type. The initial power signal may comprise a preset maximum power signal for the tag class being interrogated. The interrogator 2 may emit different maximum power signals to interrogate for different classes of tags, where each class of passive tags 12 is capable of being activated and responding for a different power level. Upon receiving (at block 54) a response from one of the tags 12 to the emitted signal, the power control circuit 10 may determine (at block 56) an indicator of a strength (e.g., amplitude) of the signal received at the responding tag 12, i.e., the reflected signal. In one embodiment, the power control circuit 10 may determine the indicator of the strength of the signal received at the tag from the Received Signal Strength Indication (RSSI) information encoded in the response signal from the tag 12. Alternatively, the power control circuit 10 may determine the indicator of the strength of the signal received at the tag from other information included in the signal or the power control circuit 10 may be enabled to directly measure the strength or amplitude of the received response from the tag 12, where the measured signal strength comprises an indicator of the strength of the signal received at the tag 12. However, the measured signal strength is likely less than the strength of the signal reflected at the tag due to environmental factors and the orientation of the antennas 6 and 14.

The power control circuit 10 may further determine (at block 58) a minimum signal strength needed to activate the tags of the tag type class which the integrator 2 is currently trying to locate. The integrator 2 may maintain information on the minimum signal strength needed to activate different classes of passive tags and make the determination of the minimum signal strength from this maintained information. The minimum signal strength may comprise the minimum signal strength received at the tag needed to activate the tag. The strength of the signal received at the tag may depend on the orientation of the tag antenna 14 with respect to the interrogator antenna 6, such that the received signal at the tag is stronger if the orientation of the tag and interrogator antennas are closer to a direct orientation and weaker if the orientation diverges from a direct orientation. If (at block 60) the determined signal strength indicator is not greater than the minimum signal strength for the responding tag 12, then control returns to block 54 to wait for a response from one of the tags because the current signal cannot be reduced without providing a sufficiently strong, e.g., minimum, signal to obtain a response from tags, such as the tag 12 for which the response signal is received. If (at block 60) the determined signal strength indicator is greater than the determined minimum, then the power control circuit 10 may use the information of the determined signal strength and minimum signal strength to determine an amount by which to adjust downward the power of the emitted interrogation signal. In one embodiment, the power control circuit 10 may determine the amount to adjust downward by determining (at block 62) a difference of the determined signal strength indicator and the minimum signal strength and then determines (at block 64) an amount of the downward adjustment based on the difference of the determined signal strength indicator and the minimum signal strength needed to active the tags. In one embodiment, the amount of the downward adjustment is the determined difference. In alternative embodiments, the downward adjustment may be based on different calculations. The power control circuit 10 then controls the transceiver 4 to adjust (at block 66) downward a power of the emitted tag interrogation signal based on the determined downward adjustment.

In one embodiment, the power control circuit 10 may implement a proportional-integral-derivative controller (PID controller) or other rate limited feedback loop to adjust the emitted signal downward based on the determined strength of the received tag response and the minimum signal strength needed to active the tag.

With the described embodiments, the power of the emitted signal used to inventory or seek passive tags 12 is reduced while maintaining a sufficient signal to continue activating and receiving responses from already located tags 12.

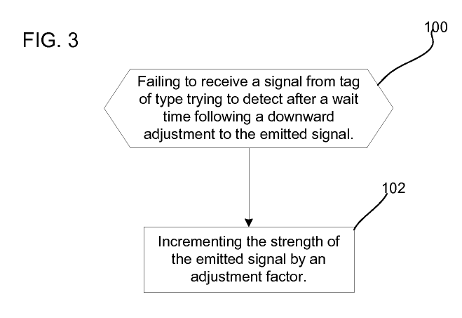

FIG. 3 illustrates additional operations that may be performed by components of the interrogator 2. Upon the power control circuit 10 detecting a failure (at block 100) to receive a signal from a tag of the type for which the signal is emitted after a predetermined wait time following a downward adjustment of the emitted signal, the power control circuit 10 may then cause the transceiver 4 to increment (at block 102) the strength of the emitted signal by an adjustment factor. For instance, tags 12 of the class the interrogator 2 is attempting to locate may have changed their position, e.g., moved away from the interrogator 2, so that a downward adjustment may cause such moved tags to be outside the electromagnetic zone of the downward adjusted signal. The described embodiments in such case may increase the strength of the emitted signal to reach tags that may have moved away from the interrogator 2.

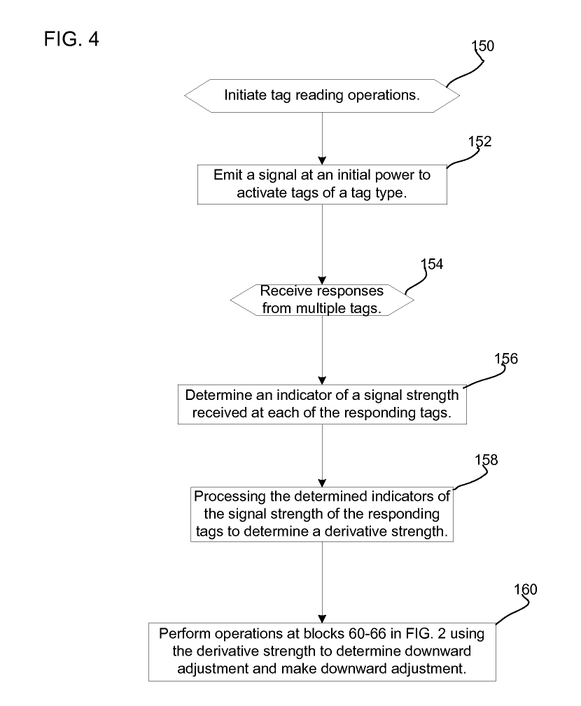

FIG. 4 illustrates an alternative embodiment where the power control circuit 10 considers the indicator of the signal strength from multiple tags of the class being interrogated to determine the downward adjustment. Upon initiating (at block 150) tag reading operations, the power control circuit 10 may cause the transceiver 4 to emit (at block 152) a signal at an initial power, e.g., the maximum power, to activate tags of a tag type or class. Upon receiving responses (at block 154) from multiple tags, the power control circuit 10 may determine (at block 156) an indicator of a strength of the signal received at each of the responding tags 12. The power control circuit 10 further processes (at block 158) the determined indicators of the signal strengths of the responding tags to determine a derivative signal strength. The derivative signal strength may comprise an average signal strength, median strength, most common signal strength (e.g., amplitude), etc. The power control circuit 10 may then perform the operations at blocks 60-66 in FIG. 2 using the derivative strength to determine the downward adjustment to use to control the transceiver 4 to lower the signal strength that is transmitted to interrogate tags of the sought tag class or type.

With the described embodiments, the power of the emitted signal used to inventory or seek passive tags 12 is reduced while maintaining a sufficient signal to continue activating and receiving responses from already located tags 12.

By reducing the power of the emitted signal, the interrogator both conserves power and reduces the likelihood of interfering with other external interrogator devices that may implement “listen before talk” (LBT) technology.

The described operations may be implemented as a method, apparatus or article of manufacture using standard programming and/or engineering techniques to produce software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), Microcontroller Units (MCU's), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. A “machine readable medium” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

In described embodiments, the tags subject to interrogation comprised passive RFID tags. In an alternative embodiment, the tags may comprise active or semi-passive tags.

In described embodiments, the interrogator and tags implemented the RFID protocol. In alternative embodiments, the interrogator and tags may implement alternative wireless technology to communicate.

In the described operations, certain operations were described as performed with respect to certain of the interrogator components. In alternative embodiments, the described operations may be performed by different components within the interrogator. Further, the interrogator may include a processor to perform other operations for the interrogator.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

A character used to represent a variable number of an element, e.g., 54c, 58b, 52b, 4b, may indicate any number of instances of the element, and may indicate different integer numbers when used with different elements or with the same element in different instances.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or that a different number of devices may be used than the multiple number shown.

The functionality and/or the features of a device may be alternatively embodied by one or more other devices which are not explicitly described as having such functionality/features. Thus, other embodiments of the present invention need not include the device itself.

The illustrated operations of FIGS. 2, 3, and 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method, comprising:
emitting a signal at an initial power to activate electronically responsive tags;
receiving a response from one of the tags to the emitted signal;
determining an indicator of a signal strength received at the responding tag; and
adjusting downward a power of the emitted signal based on the determined indicator of the signal strength.

2. The method of claim 1, wherein the tag comprises a Radio Frequency Identification (RFID) passive tag.

3. The method of claim 1, wherein determining the indicator of the signal strength comprises:
measuring a signal strength of the response from the tag.

4. The method of claim 1, wherein the tag response indicates a signal strength of the emitted signal received at the tag, wherein determining the indicator of the signal strength comprises determining the signal strength indicated in the tag response.

5. The method of claim 1, wherein adjusting the power of the emitted signal downward comprises:
determining a minimum signal strength needed to active the tags; and
determining an amount of the downward adjustment based on the indicator of the signal strength and the minimum signal strength needed to active the tags.

6. The method of claim 5, wherein the signal strength is adjusted downward if the determined indicator of the signal strength is greater than the minimum signal strength for the responding tag.

7. The method of claim 5, wherein the downward adjustment is based on a difference of the determined indicator of the signal strength and the minimum signal strength.

8. The method of claim 1, further comprising:
increasing the strength of the emitted signal in response to failing to detect a response from one tag after the downward adjustment.

9. The method of claim 1, further comprising:
receiving multiple responses from multiple of the tags to the emitted signal;
determining an indicator of the signal strength received at each of the responding tags; and
processing the determined indicators of the signal strengths of the responding tags, wherein the downward adjustment is based on the determined indicators of the signal strengths.

10. The method of claim 9, wherein processing the determined indicators of the signal strengths comprises applying a function to the determined indicators of the signal strengths to determine a derivative strength, wherein the downward adjustment is based on the derivative strength.

11. The method of claim 1, further comprising:
detecting a transmitted signal from an external interrogator; and
delaying the emitting of the signal to activate the tag in response to detecting the transmitted signal from the external interrogator, wherein the emitting of the signal to activate tags is performed in response to not detecting the transmitted signal from the external interrogator for a predetermined time.

12. A system enabled to communicate with electronically responsive tags, comprising:
a transceiver operable to:
emit a signal at an initial power to activate the tags; and
receive a response from one of the tags to the emitted signal;
a power control circuit operable to:
determine an indicator of a signal strength received at the responding tag;
and
adjust downward a power of the emitted signal based on the determined indicator of the signal strength.

13. The system of claim 12, wherein the tag comprises a Radio Frequency Identification (RFID) passive tag.

14. The system of claim 12, wherein the power control circuit is to determine the indicator of the signal strength by:
measuring a signal strength of the response from the tag.

15. The system of claim 12, wherein the tag response is to indicate a signal strength of the emitted signal received at the tag, wherein the power control circuit determines the indicator of the signal strength by determining the signal strength indicated in the tag response.

16. The system of claim 12, wherein the power control circuit adjusts the power of the emitted signal downward by:
determining a minimum signal strength needed to active the tags; and
determining an amount of the downward adjustment based on the indicator of the signal strength and the minimum signal strength needed to active the tags.

17. The system of claim 16, wherein the signal strength is adjusted downward if the determined indicator of the signal strength is greater than the minimum signal strength for the responding tag.

18. The system of claim 16, wherein the downward adjustment is based on a difference of the determined indicator of the signal strength and the minimum signal strength.

19. The system of claim 12, wherein the power control circuit is to increase the strength of the emitted signal in response to failing to detect a response from one tag after the downward adjustment.

20. The system of claim 12, wherein the transceiver is further operable to receive multiple responses from multiple of the tags to the emitted signal, and wherein the power control circuit is further operable to determine an indicator of the signal strength received at each of the responding tags and process the determined indicators of the signal strengths of the responding tags, wherein the downward adjustment is based on the determined indicators of the signal strengths.

21. The system of claim 20, wherein the power control signal processes the determined indicators of the signal strengths by applying a function to the determined indicators of the signal strengths to determine a derivative strength, wherein the downward adjustment is based on the derivative strength.

22. The system of claim 12, further enabled to communicate with external interrogators, wherein the transceiver is further operable to:
detect a transmitted signal from one of the external interrogators; and
delay emitting of the signal to activate the tag in response to detecting the transmitted signal from the external interrogator, wherein the emitting of the signal to activate tags is performed in response to not detecting the transmitted signal from the external interrogator for a predetermined time.

23. An article of manufacture implementing code or logic that is operable to cause communication with tags and is further enabled to perform:
emitting a signal at an initial power to activate tags;
receiving a response from one of the tags to the emitted signal;
determining an indicator of a signal strength received at the responding tag; and
adjusting downward a power of the emitted signal based on the determined indicator of the signal strength.

24. The article of manufacture of claim 23, wherein the tag comprises a Radio Frequency Identification (RFID) passive tag.

25. The article of manufacture of claim 23, wherein determining the indicator of the signal strength comprises:
measuring a signal strength of the response from the tag.

26. The article of manufacture of claim 23, wherein the tag response indicates a signal strength of the emitted signal received at the tag, wherein determining the indicator of the signal strength comprises determining the signal strength indicated in the tag response.

27. The article of manufacture of claim 23, wherein adjusting the power of the emitted signal downward comprises:
determining a minimum signal strength needed to active the tags; and
determining an amount of the downward adjustment based on the indicator of the signal strength and the minimum signal strength needed to active the tags.

28. The article of manufacture of claim 27, wherein the signal strength is adjusted downward if the determined indicator of the signal strength is greater than the minimum signal strength for the responding tag.

29. The article of manufacture of claim 27, wherein the downward adjustment is based on a difference of the determined indicator of the signal strength and the minimum signal strength.

30. The article of manufacture of claim 23, further comprising:
increasing the strength of the emitted signal in response to failing to detect a response from one tag after the downward adjustment.

31. The article of manufacture of claim 23, further enabled to perform:
receiving multiple responses from multiple of the tags to the emitted signal;
determining an indicator of the signal strength received at each of the responding tags; and
processing the determined indicators of the signal strengths of the responding tags, wherein the downward adjustment is based on the determined indicators of the signal strengths.

32. The article of manufacture of claim 31, wherein processing the determined indicators of the signal strengths comprises applying a function to the determined indicators of the signal strengths to determine a derivative strength, wherein the downward adjustment is based on the derivative strength.

33. The article of manufacture of claim 23, further operable to communicate with external interrogators and further enabled to perform:
detecting a transmitted signal from one of the external interrogators; and
delaying the emitting of the signal to activate the tag in response to detecting the transmitted signal from the external interrogator, wherein the emitting of the signal to activate tags is performed in response to not detecting the transmitted signal from the external interrogator for a predetermined time.
